(19) United States
(12) Patent Application Publication
(10) Pub. No.: US 2026/0116725 A1
(43) Pub. Date: Apr. 30, 2026

(54) IMAGE RECOGNITION FOR LANYARD DETECTION

(71) Applicant: Oshkosh Corporation, Oshkosh, WI (US)

(72) Inventor: Prabhu Shankar, Oshkosh, WI (US)

(73) Assignee: Oshkosh Corporation, Oshkosh, WI (US)

(21) Appl. No.: 19/086,317

(22) Filed: Mar. 21, 2025

Related U.S. Application Data
(60) Provisional application No. 63/712,603, filed on Oct. 28, 2024.

(51) Int. Cl. B66F 11/04; G06V 20/52

(52) U.S. Cl. CPC B66F 11/04; G06V 20/52

(57) ABSTRACT

A lift device includes a chassis, a platform, a lift assembly coupling the platform to the chassis, an actuator, a sensor, and a controller. The platform supports an operator and defines a work area having a deck and railing. The lift assembly raises the platform relative to the chassis. The actuator can move the platform relative to the chassis or propel the chassis. The sensor provides data indicative of a position of the operator relative to the work area. The controller is configured to receive, from the sensor, data indicative of the operator exiting the work area. In response to determining that the operator has exited the work area, the controller determines, based on the sensor data, a direction of travel of the operator, and operates at least one of the lift assembly or the actuator to move the platform according to the direction of travel of the operator.

### CROSS-REFRENCE TO RELATED APPLICATIONS

This U.S. Patent Application claims the benefit and priority to U.S. Provisional Patent Application No. 63/712,603, filed Oct. 28, 2024, the entire contents of which is incorporated herein by reference.

### BACKGROUND

The present disclosure relates generally to the field of lift devices. More specifically, the present disclosure relates to sensor systems for lift devices.

Some lift devices include platforms that support an operator. Such platforms are often supported by boom assemblies that facilitate vertical and/or horizontal movement of the platform.

### SUMMARY

At least one embodiment relates to a lift device. The lift device includes a chassis, a platform, a lift assembly that couples the platform to the chassis, an actuator, a sensor, and a controller. The platform supports an operator and defines a work area having a deck and railing. The lift assembly raises the platform relative to the chassis. The actuator can move the platform relative to the chassis or propel the chassis. The sensor provides sensor data indicative of a position of the operator relative to the work area. The controller is communicatively coupled to the lift assembly and the actuator. The controller is configured to receive, from the sensor, data indicative of the operator exiting the work area. In response to determining that the operator has exited the work area, the controller determines, based on the sensor data, a direction of travel of the operator. The controller operates at least one of the lift assembly or the actuator to move the platform according to the direction of travel of the operator.

Another embodiment relates to a lift device. The lift device includes a chassis, a platform, a lift assembly coupling the platform to the chassis, an actuator, a camera, and a controller. The platform supports an operator and defines a work area having a deck and railing. The lift assembly raises the platform relative to the chassis. The actuator can move the platform relative to the chassis or propel the chassis. The camera is configured to collect image data indicative of a field of view of the camera. The controller is communicatively coupled to the lift assembly and the actuator. The controller is configured determine, based on the image data, if the lanyard is engaged with the attachment point, and in response to determining that the lanyard is not engaged with the attachment point, limit movement of at least one of the lift assembly or the actuator.

Yet another embodiment relates to a method for controlling operation of a lift device. The method includes receiving, from a sensor, data indicative of an operator exiting a work area of a platform of the lift device and determining, based on the sensor data, a direction of travel of the operator in response to determining that the operator has exited the work area. The method further includes operating at least one of a lift assembly or an actuator to move a platform of a lift device according to the direction of travel of the operator. The method includes determining, based on the sensor data, a speed of travel of the operator, determining the speed of travel exceeds a threshold, wherein the speed of travel exceeding the threshold indicates the operator is falling, and transmitting a signal to a remote system indicating that the operator has fallen.

### BRIEF DESCRIPTION OF THE DRAWINGS

FIG. 1 is a front perspective view of a boom lift, according to an exemplary embodiment;

FIG. 2 is a front perspective view of a platform assembly of the boom lift of FIG. 1;

FIG. 3 is a front perspective view of a platform assembly of the boom lift of FIG. 1, having a fall arrest system;

FIG. 4 is a front view of a lanyard and personal protective equipment (PPE) system of the platform assembly of FIGS. 2 and 3, according to an exemplary embodiment;

FIG. 5 is a depiction of various embodiments of the lanyard and harness of the lanyard and PPE system of FIG. 4;

FIG. 6 is a side view of the platform assembly of FIG. 2;

FIG. 7A is a perspective view of an attachment point of the platform assembly of FIG. 2, according to an exemplary embodiment;

FIG. 7B is a rear perspective view of the platform assembly of FIG. 1 outfitted with several of the attachment points of FIG. 7A;

FIG. 8 is a rear perspective view of various alternative configurations of the platform assembly of FIG. 2, each having a different size;

FIG. 9 is a block diagram of a control system for the lanyard and PPE system of FIG. 3, according to an exemplary embodiment;

FIG. 10 is a flow diagram of a process for implementing the lanyard and PPE system of FIG. 3, according to an exemplary embodiment;

FIG. 11 is a depiction of several images captured by a camera of the control system of FIG. 9 under various environmental conditions experienced by the lanyard and PPE system of FIG. 4;

FIGS. 12A and 12B are block diagrams illustrating a neural network model for the lanyard and PPE system of FIG. 4, according to various exemplary embodiments;

FIG. 13 is an image captured by the camera of the control system of FIG. 9; and

FIG. 14 is a flow diagram of a process for monitoring an operator, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a lift device having a platform, a sensor, and a controller. The platform supports an operator and defines a work area having a deck and railing. The sensor provides sensor data indicative of a position of the operator relative to the work area. In some embodiments, the sensor is a camera that captures image data indicative of a position of the operator relative to the platform. The controller is communicatively coupled to a lift assembly and/or an actuator of the lift device, such that the controller may operate the lift assembly and/or actuator to raise, lower, shift horizontally, or the like. The controller is configured to receive, from the sensor, data indicative of an operator position relative to the work area, such as for example an operator exiting or leaving the work area. In response to determining that the operator position relative to the work area has changed for example the operator has exited the work area, the controller may determine a direction of travel of the operator. The controller may operate at least one of a lift assembly or an actuator of the lift device to move the platform according to the direction of travel of the operator. Technically and beneficially, moving the platform according to the direction of travel of an operator who has exited the platform may maintain a closer distance between the platform the operator relative to a stationary lift device. In some situations, a user may trip or fall when disconnected from the platform (e.g., when personal protective equipment such as lanyards are manually de-coupled from the platform). By moving the platform according to the direction of travel of an operator who has exited the platform, the platform may catch a falling operator or prevent the operator from falling farther than they otherwise would (e.g., had the platform not been nearby/close to the operator during travel).

Additionally or alternatively, the controller may determine, based on image data from the camera, if an operator's personal protective equipment, such as a lanyard is engaged with an attachment point on the platform. In response to determining that the lanyard is not engaged with the attachment point while an operator is within the work area, the controller may limit movement of the lift device until the controller determines that the lanyard is engaged with the attachment point while the operator is within the work area.

### Lift Device

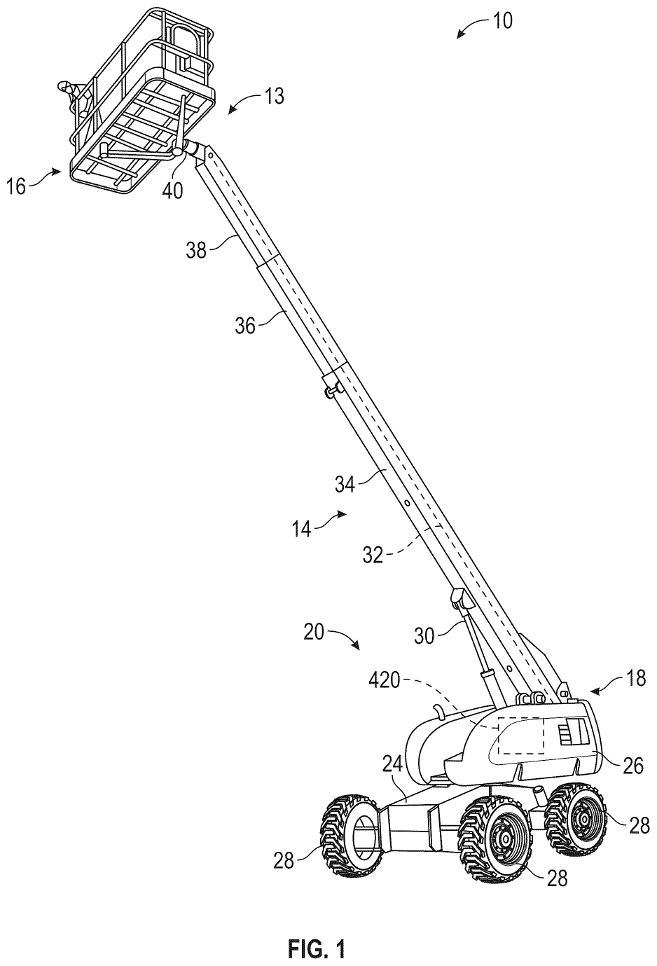

According to the exemplary embodiment shown in FIG. 1, a lift device (e.g., an aerial work platform, a telehandler, etc.), shown as lift device 10, includes a chassis or ground console, shown as chassis 20, and a work implement (e.g., a work platform, forks, a bucket, etc.), shown as platform assembly 16. The platform assembly 16 is coupled to the chassis 20 by a boom assembly or boom, shown as lift assembly 14. According to an exemplary embodiment, platform assembly 16 supports one or more operators (e.g., users, workers, etc.) 5. In some embodiments, the lift device 10 includes various accessories or tools coupled to the platform assembly 16 for use by the worker. For example, the platform assembly 16 may be equipped with pneumatic tools (e.g., impact wrench airbrush, nail guns, ratchets, etc.), plasma cutters, and spotlights, among other alternatives. While depicted herein as a boom lift, the lift device 10 may be configured as a different type of lift device, such as a telehandler, an articulating boom lift, a towable boom lift, a fully electric boom lift, a hybrid-electric boom lift, a vertical lift, a scissor lift, a mobile elevating work platform, a fire apparatus, etc. or any other type of device including a platform that supports one or more operators.

The lift assembly 14 has a first or proximal end 18 pivotally coupled to the chassis 20 and a second or distal end 13 opposite the proximal end 18. The distal end 13 is pivotally coupled to the platform assembly 16. By pivoting the lift assembly 14 at the proximal end 18, the platform assembly 16 may be elevated or lowered to a height above or below a portion of the chassis 20. The lift assembly 14 has a plurality of telescoping segments that facilitate moving the distal end 13 and the platform assembly 16 closer to or away from the proximal end 18 and the chassis 20.

In some embodiments, the chassis 20 includes a chassis, base, or frame, shown as base frame 24. The base frame 24 is coupled to a turntable 26. According to exemplary embodiment, the proximal end 18 of the lift assembly 14 is pivotally coupled to the turntable 26. According to an alternative embodiment, the chassis 20 does not include a turntable 26, and the lift assembly 14 is coupled directly to the base frame 24 (e.g., the lift assembly 14 may be provided as part of a telehandler). According to still another alternative embodiment, the lift assembly 14 is incorporated as part of an articulating boom lift that includes multiple sections coupled to one another (e.g., a base section coupled to the chassis 20, an upper section coupled to the platform assembly 16, and one or more intermediate sections coupling the base section to the upper section, etc.).

In some embodiments, the lift device 10 is mobile and the base frame 24 includes tractive elements, shown as wheel and tire assemblies 28. The wheel and tire assemblies 28 may be driven using a prime mover and steered to maneuver the lift device 10. In other embodiments, the base frame 24 includes other devices to propel or steer the lift device 10 (e.g., tracks). In still other embodiments, the lift device 10 is a trailer that is towed by another vehicle, and the base frame 24 includes one or more wheels or elements configured to support the lift device 10. In still other embodiments, the lift device 10 is a stationary device and the base frame 24 lacks any wheels or other elements to facilitate the movement of the lift device 10 and may instead include legs or other similar structures that facilitate stationary support of the lift device 10.

The turntable 26 is coupled to the base frame 24 such that the turntable 26 may be rotated relative to the base frame 24 about a vertical axis of rotation (e.g., by a motor). According to an exemplary embodiment, the chassis 20 houses one or more pumps and/or motors that power one or more functions of the lift device 10 (e.g., extension and/or movement of the lift assembly 14 and the platform assembly 16, rotation of the turntable 26, rotation of the wheel and tire assemblies 28, etc.). The pumps and/or motors may drive the movement directly, or may provide electrical energy or pressurized hydraulic fluid to another actuator. The lift device 10 may include an onboard engine (e.g., a gasoline or diesel engine), may receive electrical energy from an external source through a tether (e.g., a cable, a cord, etc.), may include an on-board generator set to provide electrical energy, may include a hydraulic pump coupled to a motor (e.g., an electric motor, an internal combustion engine, etc.), and/or may include an energy storage device (e.g., battery).

According to an exemplary embodiment, the turntable 26 includes an internal structure (e.g., one or more bosses coupled to a pin, etc.) configured to support the lift assembly 14. The internal structure may interface with the proximal end 18 of the lift assembly 14 to pivotally couple the lift assembly 14 to the chassis 20. A lift actuator, shown as hydraulic cylinder 30, is coupled between the turntable 26 and the lift assembly 14. According to an exemplary embodiment, the hydraulic cylinder 30 extends or retracts to raise or lower the lift assembly 14 (e.g., to rotate the distal end 13 of the lift assembly 14 relative to the turntable 26). In other embodiments, the hydraulic cylinder is replaced with or additionally includes another type of actuator (e.g., an electric motor, a lead screw, a ball screw, an electric linear actuator, a pneumatic cylinder, etc.).

According to an exemplary embodiment, the lift assembly 14 is a telescoping boom including a series of segments or sections that are configured to translate relative to one another along a longitudinal axis 32. The longitudinal axis 32 extends along the length of the lift assembly 14 between the proximal end 18 and the distal end 13. As shown in FIG. 1, the lift assembly 14 includes three sections: a first or base boom section 34, a second, middle, or intermediate boom section 36, and a third, upper, or fly boom section 38. The base boom section 34 is the most proximal section, and the fly boom section 38 is the most distal section, with the intermediate boom section 36 extending between and coupling the base boom section 34 and fly boom section 38. The base boom section 34 is coupled to the turntable 26 and the fly boom section 38 is coupled to the platform assembly 16. The lift assembly 14 may include an actuator (e.g., a hydraulic cylinder, an electric linear actuator, etc.) that controls the telescoping of the lift assembly 14.

According to an exemplary embodiment, the base boom section 34, the intermediate boom section 36, and the fly boom section 38 have tubular cross sectional shapes (e.g., to facilitate receiving boom sections within one another). The base boom section 34, the intermediate boom section 36, and the fly boom section 38 may have a variety of cross sectional shapes (e.g., hexagonal, round, square, pentagonal, etc.). While the embodiment shown in FIG. 1 has three boom segments, in other embodiments, the lift assembly 14 includes more or fewer segments.

In some embodiments, the lift assembly 14 further includes a linkage, shown as connecting linkage 40, which couples the platform assembly 16 to the fly boom section 38. According to an exemplary embodiment, the connecting linkage 40 includes a rotator (e.g., a rotating joint or motor, a hydraulic cylinder, etc.) that drives relative rotation between the lift assembly 14 and the platform assembly 16. According to an exemplary embodiment, the connecting linkage 40 includes a jib (e.g., a four bar linkage) that facilitates translation between the lift assembly 14 and the platform assembly 16.

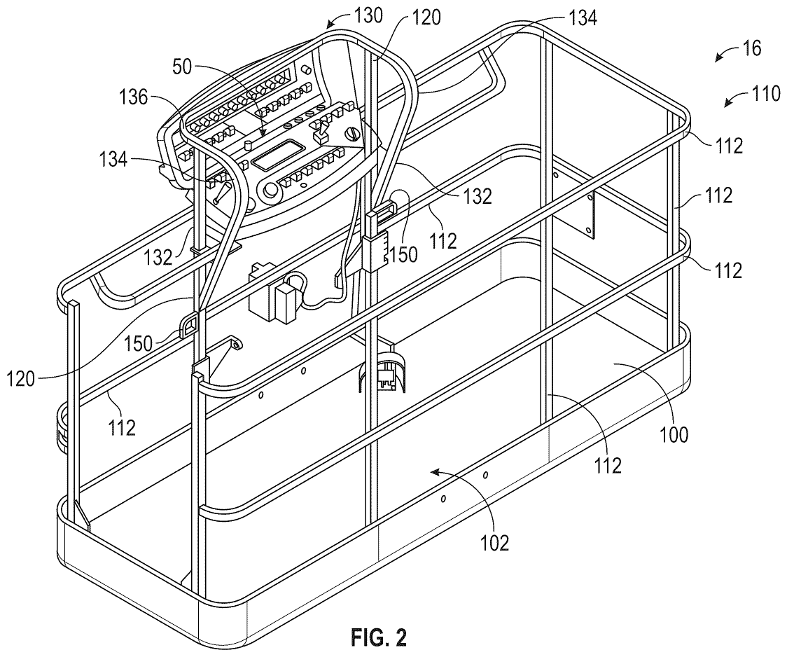

According to an exemplary embodiment, the connecting linkage 40 includes both a rotator and a jib. Such connecting linkages 40 may facilitate the platform assembly 16 remaining level as the lift assembly 14 is raised or lowered. The connecting linkage 40 may be controlled by a self-leveling system including a slave cylinder (e.g., the slave cylinder may operate based on the position of the hydraulic cylinder 30). In other embodiments, movement of the connecting linkage 40 is otherwise controlled (e.g., by manual or computer control of a hydraulic or electric actuator (e.g., a cylinder, a motor, etc.). In some embodiments, the connecting linkage 40 supports a camera (such as a camera 300 as depicted with reference to FIG. 2) in order to perform the systems and methods herein related to a control system for a lanyard and PPE system 350, as described in greater detail below.

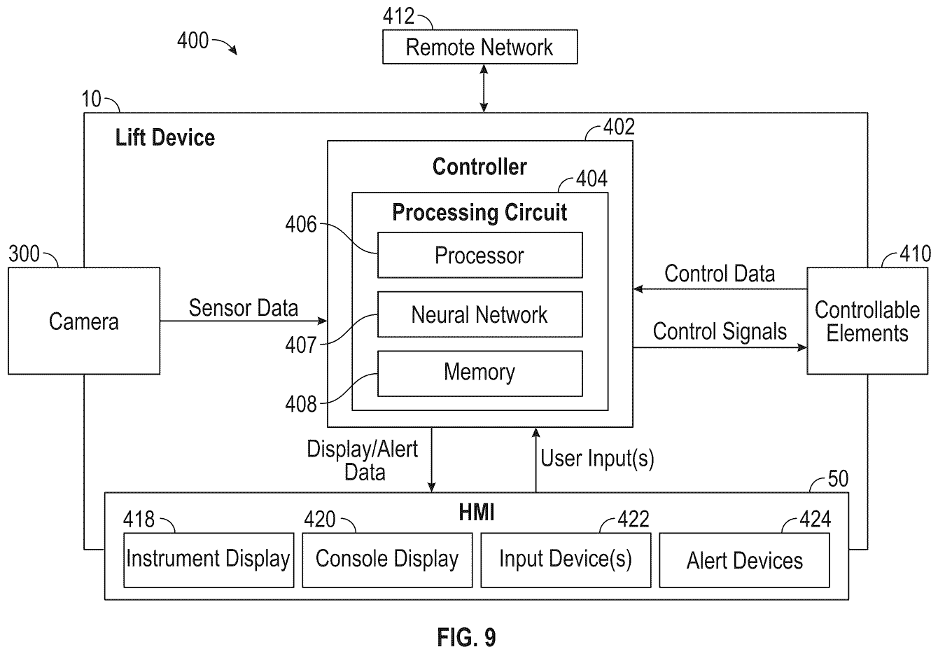

In some embodiments, the lift device 10 may include a controller 402 within the chassis 20 (or some other part of the lift device 10). The controller 402 may be part of a control system 400 (e.g., shown in FIG. 9) in order to perform the systems and methods described herein.

Referring now to FIG. 2, the platform assembly 16 is shown in further detail. The platform assembly 16 is configured to provide a work area 102 for the operator of the lift device 10 to stand/rest upon. The platform assembly 16 can be pivotally coupled to the distal end 13 of the lift assembly 14 (e.g., the connecting linkage 40). The lift device 10 is configured to facilitate the operator accessing various elevated areas (e.g., lights, platforms, the sides of buildings, building scaffolding, trees, power lines, etc.). The lift device 10 may use various electrically-powered motors and electrically-powered linear actuators or hydraulic cylinders to facilitate elevation and/or horizontal movement (e.g., lateral movement, longitudinal movement) of the platform assembly 16 (e.g., relative to the chassis 20, or to a ground surface that the chassis 20 rests upon).

The platform assembly 16 can include a human-machine interface (HMI) (e.g., an operator interface), shown as the HMI 50. The HMI 50 is configured to receive operator inputs from the operator at or upon the platform assembly 16 to facilitate operation of the lift assembly 14. The HMI 50 can include any number of buttons, levers, switches, keys, etc., or any other operator input device configured to receive an operator input to operate the lift assembly 14.

The platform assembly 16 includes a base member, a base portion, a platform, a standing surface, a shelf, a work platform, a floor, a deck, etc., shown as a deck 100. The deck 100 provides a floor surface for one or more workers to stand upon as the platform assembly 16 is raised and lowered. The worker may stand within the work area 102 positioned above the deck 100.

The platform assembly 16 includes a railing assembly 110 that extends upward from the deck 100 and at least partially surrounds the work area 102. The railing assembly 110 includes various members, beams, bars, guard rails, rails, railings, etc., shown as rails 112. The rails 112 extend along substantially an entire perimeter of the deck 100. The rails 112 provide one or more members for the operator of the lift device 10 to grasp while using the lift device 10 (e.g., to grasp while operating the lift device 10 to elevate the platform assembly 16) and contain the operator within the work area 102. The rails 112 can include members that are substantially horizontal to the deck 100. The rails 112 can also include vertical structural members that couple with the substantially horizontal members. The vertical structural members can extend upwards from the deck 100. One or more of the rails may be coupled to and support the HMI 50.

In some embodiments, the rails 112 include a pair of frame members, shown as vertical rails 120, that extend vertically upward from the deck 100. The vertical rails 120 are positioned on opposite sides of the HMI 50 such that the HMI 50 extends laterally between the vertical rails 120. A rail, shown as cage 130, is fixedly coupled to the vertical rails 120 and extends around the HMI 50. Specifically, the cage 130 extends laterally between the vertical rails 120, longitudinally forward of the vertical rails 120, and longitudinally rearward of the vertical rails 120. The cage 130 includes a pair of inclined portions 132, each extending longitudinally forward and vertically upward from a middle portion of one of the vertical rails 120. The cage 130 further includes a pair of curved portions 134, each coupled to an upper end of one of the inclined portions 132. The curved portions 134 each extend upward and longitudinally rearward from the corresponding inclined portion 134. A u-shaped horizontal portion 136 is coupled to both of the curved portions 134. The horizontal portion 136 extends longitudinally rearward from the curved portions 134 and laterally between the curved portions 134. The horizontal portion 136 is coupled to the top end of each vertical rail 120. The curved portions 134 and the horizontal portion 136 both extend above the HMI 50.

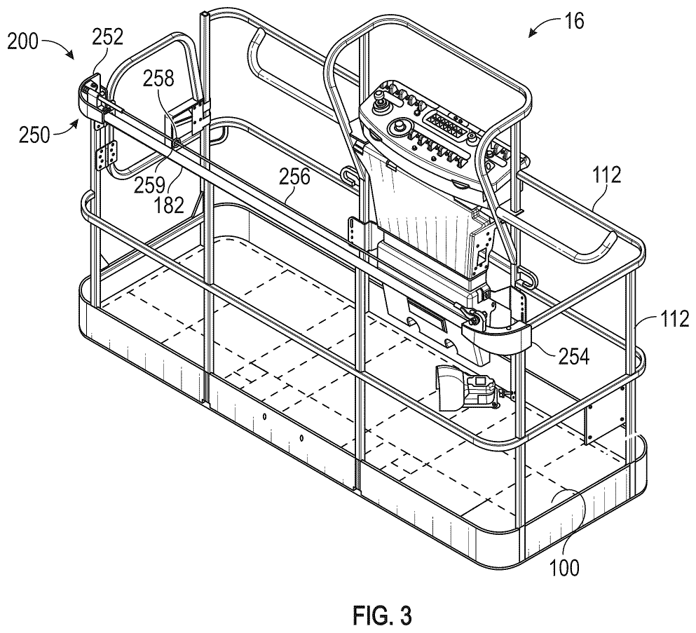

Referring to FIG. 3, platform assembly 16 having a fall arrest system 200 is shown, according to an embodiment. The fall arrest system 200 includes a movable anchor point assembly, fall arrest system, fall arrest assembly, or lifeline, shown as anchor assembly 250. The anchor assembly 250 includes (a) a first bracket, fixture, frame, component, or assembly, shown as bracket 252, (b) a second bracket, fixture, frame, component, or assembly, shown as bracket 254, (c) a connecting assembly, support member, elongate assembly, horizontal member, lateral member, or line, shown as cable assembly 256, and (d) an annular member, movable attachment point, harness attachment member, anchor, ring, or harness adapter, shown as anchor 258. The bracket 252 and the bracket 254 are coupled to and extend above the top rail 112 at opposite ends of the first straight section 182. The cable assembly 256 extends between and is coupled to the bracket 252 and the bracket 254 such that the cable assembly 256 is held taut. The anchor 258 defines an aperture 259 that receives the cable assembly 256 therethrough such that the anchor 258 is slidably coupled to the cable assembly 256. The anchor 258 can slide laterally along the length of the cable assembly 256 between the first bracket 252 and the second bracket 254.

In operation, an operator connects one of the connectors (e.g., at the first end 212 and/or the second end 214) of the lanyard 210 to the anchor 258. Alternatively, the anchor 258 may be omitted, and the connector may be directly coupled to the cable assembly 256. The anchor 258 is captured along the cable assembly 256 and between the first bracket 252 and the second bracket 254 such that the anchor assembly 250 couples the lanyard 210 to the platform 16. The anchor 258 is free to move along the length of the cable assembly 256 in response to a lateral force being applied to the lanyard 210 (e.g., when an operator walks along the width of the deck 100). Accordingly, the anchor assembly 250 permits free movement throughout the work area 102 without the operator having to manually disconnect and reconnect the connector. Further, should an operator choose to move outside of the work area 102 (e.g., through an opening in the railing 112), the lanyard 210 can stay connected to the anchor assembly 250 throughout this movement. As the operator moves from the work area 102 to the exterior surface, the lanyard 210 simply moves over the top of the anchor assembly 250. The operator then has unobstructed lateral movement outside of the work area 102. In the event that an operator falls from the platform 16, the cable assembly 256 supports the weight of the operator regardless of the initial lateral position of the anchor 258.

The bracket 252 and the bracket 254 are selectively coupled to the vertical frame rail 112. Accordingly, the anchor assembly 250 can be outfitted onto a variety of different platforms and/or in a variety of different positions. The anchor assembly 250 may be sold as an aftermarket product (e.g., a retrofit kit) and outfitted onto existing platforms. Additionally, the anchor assembly 250 can be disassembled and removed from the platform 16. The anchor assembly 250 may then be outfitted onto a different platform assembly 16 or into a different position on the same platform 16. By way of example, in a situation where the benefits of the anchor assembly 250 are only needed occasionally, a small number of anchor assemblies 250 may be able to service a large number of lift devices 10. By way of another example, the anchor assembly 250 may be removed from the front portion of the vertical frame rail 112 and reinstalled on the right portion of the vertical frame rail 112. In situations where the new location of the anchor assembly 250 requires a different spacing between the bracket 252 and the bracket 254 (e.g., the anchor assembly 250 is required to span a larger or shorter length), the cable assembly 256 may be replaced with another cable assembly 256 of a different length.

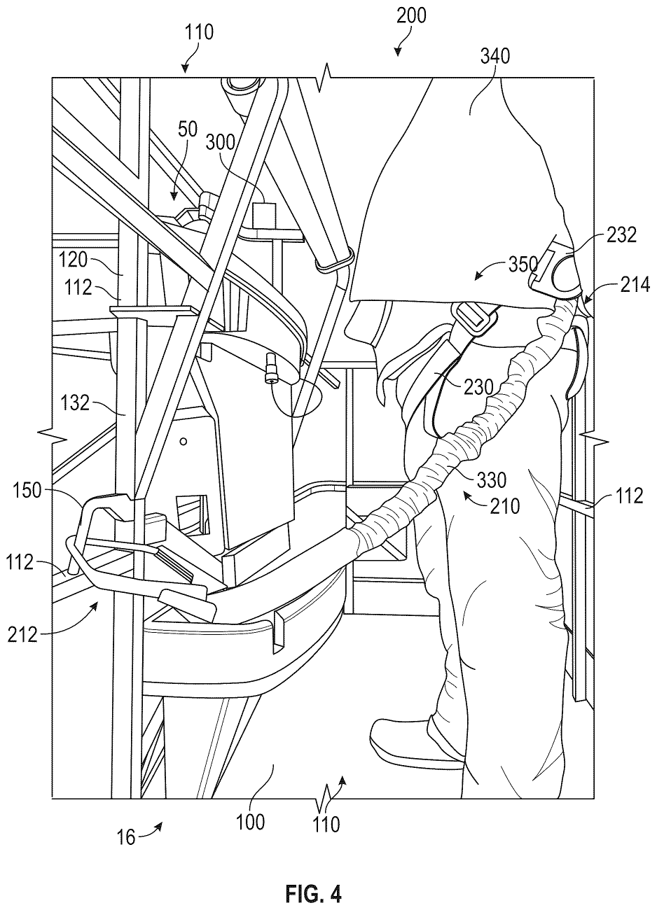

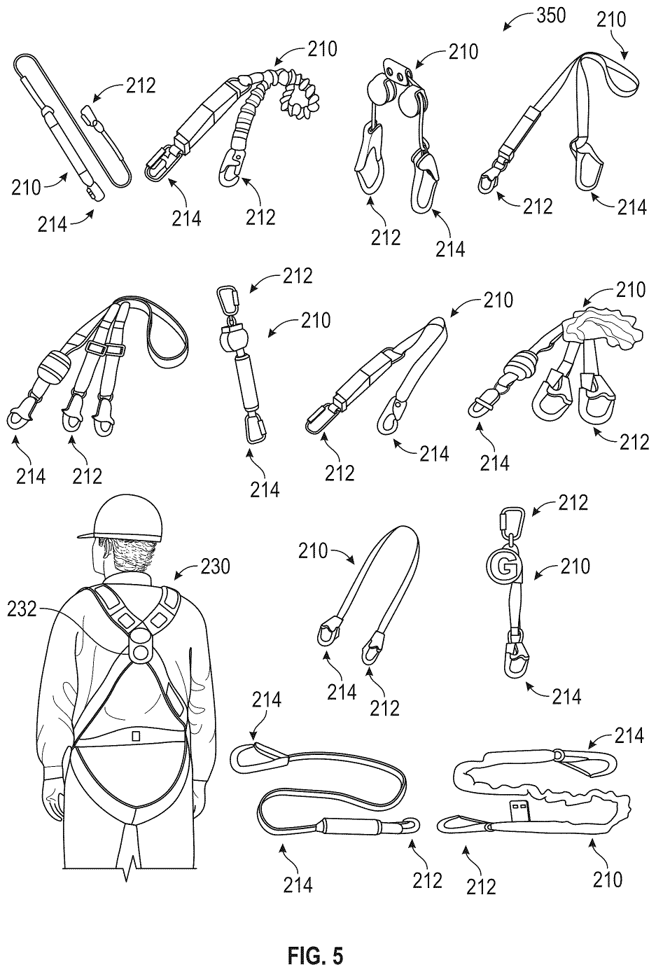

Referring to FIG. 4, a personal protective equipment (PPE) system 350 for the lift device 10 is shown according to an exemplary embodiment. The PPE system 350 includes a tensile member, shown as lanyard 210. The attachment points 150 may each receive an end of a lanyard 210 (e.g., depicted in various embodiments with reference to FIG. 5) in order to secure the operator to the platform assembly 16 (e.g., on top of the deck 100). For example, the lanyard 210 may include a first end 212 and a second end 214. The first end 212 may include a mechanical device or coupler (e.g., a hook, claw, carabiner, cuff, etc.) configured to engage (e.g., receive) the attachment point 150, in order to provide a secure selective coupling of the first end 212 of the lanyard 210 to the platform assembly 16. By way of example, a hook of the first end 212 may extend around the attachment point 150 and extend through the aperture 162. The lanyard 210 may further include a second end 214 with a second mechanical device or coupler configured to be coupled to a brace, shown as harness 230, of the PPE system 350.

The harness 230 is worn by, and secured to, the operator. By way of example, the harness 230 may include straps that define apertures that receive the limbs (e.g., arms and legs) of the operator. In some embodiments, the lanyard 210 can be sized so that the operator can move to specified locations about the platform assembly 16 (e.g., up to the perimeter of the platform assembly 16 as defined by the rails 112, up to a point outside the perimeter of the platform assembly 16 such that the operator can partially lean out of the perimeter of the platform assembly 16, throughout the work area 102, and so on, as defined by various implemented safety metrics for operation of the lift device 10). The harness 230 further includes an interface, shown as ring 232, that is configured to engage (e.g., selectively couple to) the second end 214 of the lanyard 210.

The operator may further wear an outer clothing layer (e.g., a vest, a coat, a jacket, etc.), shown as jacket 340 of the PPE system 350. The jacket 340 may be sized and otherwise configured to be worn over the harness 230, such that the second end 214 may be securely coupled to the harness 230 while also preventing contact with the harness 230 that might obstruct the integrity of the harness 230 and lanyard 210. As shown in FIG. 4, the jacket 340 defines an aperture through which the ring 232 extends. Together, the harness 230, the jacket 340, the lanyard 210, and the attachment point 150 may form the PPE system 350.

Referring to FIG. 5, various depictions of a personal protective equipment (PPE) system 350 for the lift device 10 are shown according to an exemplary embodiment. The PPE system 350 includes a tensile member, shown as lanyard 210. The attachment points 150 may each receive an end of a lanyard 210 in order to secure the operator to the platform assembly 16 (e.g., on top of the deck 100). For example, the lanyard 210 may include a first end 212 and a second end 214. The first end 212 may include a mechanical device or coupler (e.g., a hook, claw, carabiner, cuff, etc.) configured to engage (e.g., receive) the attachment point 150, in order to provide a secure selective coupling of the first end 212 of the lanyard 210 to the platform assembly 16. By way of example, a hook of the first end 212 may extend around the attachment point 150 and extend through the aperture 162. The lanyard 210 may further include a second end 214 with a second mechanical device or coupler configured to be coupled to a brace, shown as harness 230, of the PPE system 350.

The lanyard 210 and the harness 230 are shown according to various embodiments. The PPE system 350 may be usable with a variety of interchangeable lanyards 210 and harnesses 230. The configuration of the first end 212 and the second end 214 of the lanyard 210 may be varied. By way of example, the first end 212 and the second end 214 may each include one or more (e.g., two) hooks to interface with the attachment point 150 or the ring 232. In some embodiments, the lanyard 210 includes one or more reels that vary a length of the lanyard 210. In the harness 230, the ring 232 may be positioned along the back and/or the side of the operator.

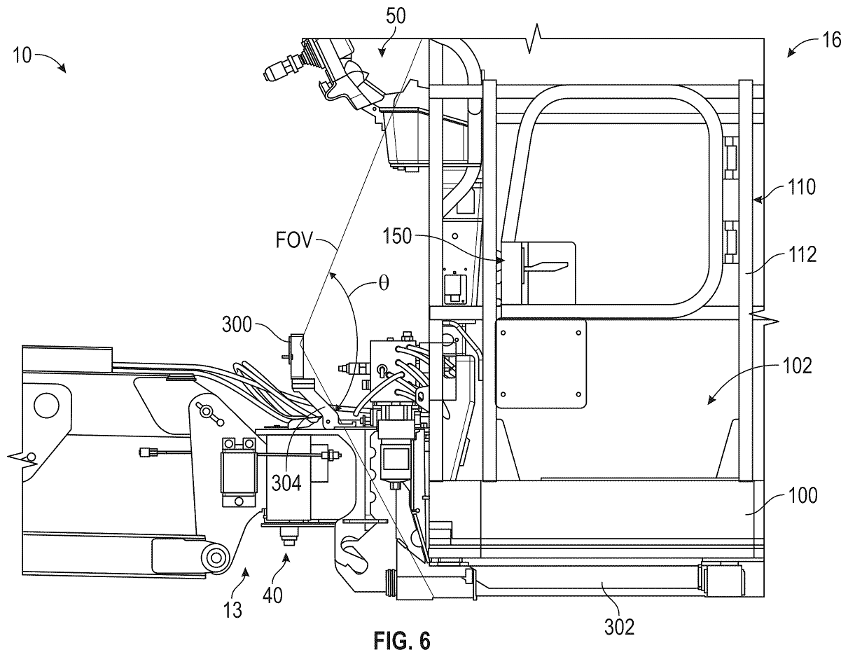

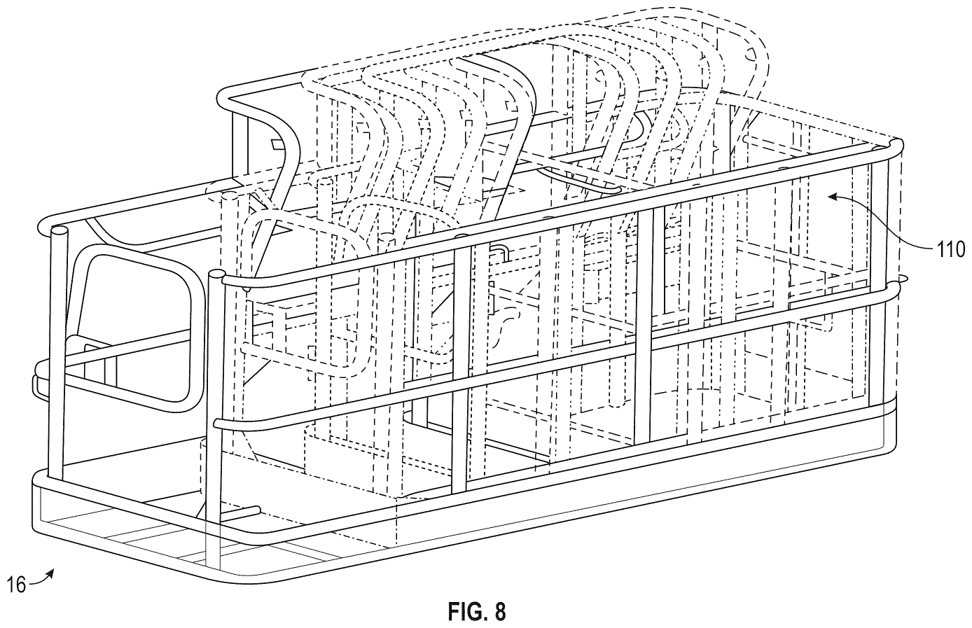

Referring now to FIG. 6, the lift device 10 includes a sensor, shown as camera 300, that monitors a state or condition (e.g., operation, integrity, engagement, etc.) of the PPE system 350. In some embodiments, the camera 300 may collect image data in and around the platform assembly 16. Such image data may be used to determine whether the operator (if present aboard the platform assembly 16) has the lanyard 210 attached to the attachment point 150. Such image data may further be used to determine whether the operator is wearing the harness 230 and the jacket 340. Such image data may be transmitted to a controller (e.g., the controller 402 of FIG. 8) in order to perform such determinations.

As shown in FIGS. 1 and 6, a camera 300 may be mounted (e.g., coupled, welded, attached, supported by, etc.) in a location that, depending on the viewable scope of the camera 300, allows the camera 300 to collect image data as necessary for the control system 400 to perform the systems and methods described herein. As shown in FIG. 5, the camera 300 is coupled to the platform 16, such that a position and orientation (e.g., pose) of the camera 300 relative to the platform assembly 16 is fixed. An arm 302 extends beneath the platform assembly 16 and is fixedly coupled to the platform 16. A bracket 304 extends upward from the arm 302, and the camera 300 is fixedly coupled to a distal end of the bracket 304. The bracket 304 is coupled to the connecting linkage 40. By fixing the position and orientation of the camera 300 relative to the platform 16, the platform assembly 16 maintains a fixed position in a field of view FOV of the camera 300, as shown in FIG. 5, regardless of the movement of the lift assembly 14.

Referring specifically to FIG. 6, a side view of the distal end 13 and platform assembly 16 of the lift device 10 is shown, according to an embodiment. The placement of the camera 300 in FIG. 5 may avoid obstruction of the camera 300. The platform assembly 16 may be intended to carry one or more operator(s) along with other tools and equipment. The operator may carry their toolbox and place the toolbox immediately behind the attachment point 150, the operator may place a generator that may partially obstruct a line of sight toward the attachment point 150 from the work area 102, or the operator may stand right behind the attachment point 150, blocking the view of the attachment point 150 from certain directions. The placement of the camera 300 in FIG. 5 at a location forward of the railing assembly 110 may avoid such obstacles.

The camera 300 may alternatively be mounted (e.g., coupled, welded, attached, supported by, etc.) to the rails 112. In other embodiments, the camera 300 may be mounted on the connecting linkage 40, or some other part of the lift device 10 that moves relative to the platform 16. Accordingly, the camera 300 may be disposed at various locations around platform assembly 16 to provide image data (or other useful information) to the controller 402.

The field of view FOV of the camera 300 may be substantially conical and have an angle Θ. In some embodiments, the camera 300 includes a 180° wide angle (i.e., the angle Θ is 180°). In some embodiments, the camera 300 provides image data in accordance with a 1280×960 pixel distribution with MJPEG or H.265 compression. In other embodiments, the camera 300 provides image data with a 1920×1080 pixel distribution. In other embodiments still, the camera 300 is configured differently (e.g., 360° image data, other pixel distributions, etc.).

While depicted herein as including a camera 300, the lift device 10 can include, or in fact can be, other sensors. For example, the lift device 10 can be, or include any, one and/or a combination of camera(s), proximity sensor(s), infrared sensor(s), electromagnetic sensor(s), capacitive sensor(s), photoelectric sensor(s), inductive sensor(s), radar sensor(s), ultrasonic sensor(s), Hall Effect sensor(s), fiber optic sensor(s), Doppler Effect sensor(s), magnetic sensor(s), laser sensor(s) (e.g., LIDAR sensors), sonar sensor(s), and/or the like. Accordingly, any reference herein to the camera 300 may also apply to these other types of sensors.

In some embodiments, the camera 300 includes an image capture device such as visible light cameras, full-spectrum cameras, image sensors (e.g., charged-coupled device (CCD), complementary metal oxide semiconductor (CMOS) sensors, etc.), or any other type of suitable object sensor or imaging device. Sensor data captured by the camera 300 may include, for example, raw image data from one or more cameras (e.g., visible light cameras) and/or proximity data from one or more sensors (e.g., LIDAR, radar, etc.) that may be used to detect objects. In other embodiments, sensor data captured by the camera 300 is video feed data obtained from the camera 300 regarding one or more areas in and/or surrounding platform assembly 16. For example, the sensor data may be, or include, video feed data (e.g., live or real-time video feed data) of the front, sides, rear, and/or interior of the platform assembly 16. In some embodiments, multiple cameras 300 may be used in order to provide multiple feeds of image data to the controller 402, which may be configured to compile (e.g., cross-reference based on known relative locations of the multiple cameras 300) the image data.

In some embodiments, the camera 300 is active during the operation of the platform assembly 16. Additionally or alternatively, the camera 300 may become active in response to a detected operation mode of the platform assembly 16. For example, the camera 300 may activate in response to another sensor (e.g., a low-power camera, a motion detector, etc.) detecting the presence of the operator aboard the platform assembly 16.

In some embodiments, the camera 300 (e.g., in conjunction with the control system 400) is configured to determine a number of operator(s) 5 (e.g., 1, 2, 3, 5, etc.) about (e.g., supported by, standing on) the platform assembly 16. In some embodiments, an additional camera 300 (or a different camera or other detection device) may be positioned on or around the HMI 50 (or on the rails 112) in order to determine the number of operators present. The camera 300 and/or control system 400 may in turn provide individual determinations regarding multiple attachment points 150, lanyards 210, harnesses 230 and/or jackets 330 with respect to the multiple operators in terms of assessing the integrities of the lanyard and PPE systems 350.

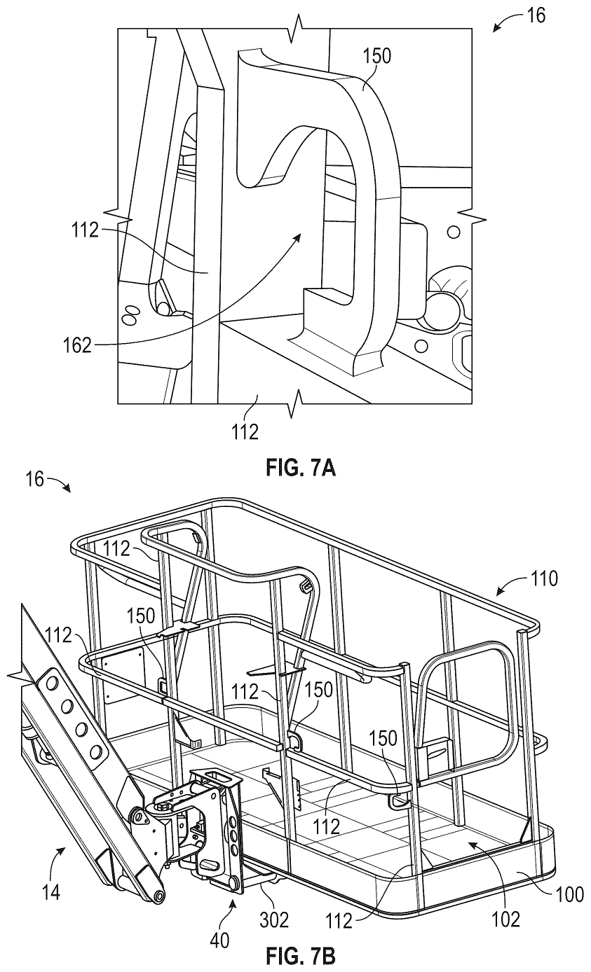

Referring to FIG. 7A, a perspective view of the attachment point 150 is shown, according to an embodiment. The platform assembly 16 includes a series of attachment points (e.g., loops, receivers, hooks, eyes, etc.), shown as attachment points 150. The attachment points 150 may extend from (e.g., may be fixedly coupled to) one of the vertical rails 120 or other point on the railing assembly 110. As shown in FIG. 7A, an attachment point 150 includes a body or hook, shown as attachment point 150. The attachment point 150 has a first end fixedly coupled (e.g., welded) to a vertical frame rail 112 and a second end fixedly coupled to a horizontal frame rail 112. An aperture 162 is defined between the attachment point 150, the vertical frame rail 112, and the horizontal frame rail 112.

Referring to FIG. 7B, the platform assembly 16 is shown to include three attachment points 150. In some embodiments, the PPE system 350 may be configured to have a single harness 230 coupled to multiple attachment points 150 via multiple lanyards 210. In other embodiments, the platform assembly 16 may be configured to support multiple operators OP, and thus include at least one attachment point 150 for each of the operators OP. By way of example, each attachment point 150 may be outfitted with a corresponding lanyard 210, harness 230, and jacket 340.

Referring now to FIG. 8, the platform assembly 16 is shown according to various embodiments of different dimensions. For example, platform dimensions may include: (i) 30″×36″; (ii) 30″×48″; (iii) 36″×60″; (iv)30″×72″; (v)36″×72″; (vi) 36″×96″; and so on. In FIG. 8, each different line type (e.g., solid, dashed, etc.) represents a different size (e.g., width) the platform 16.

Referring now to FIG. 9, a block diagram of the control system 400 is shown, according to some embodiments. The control system 400 may include the camera 300, the controller 402, a remote network 412, controllable elements 410, and the HMI 50. As shown in greater detail, the HMI 50 may include various displays and user input devices 422 (e.g., buttons, switches, levers, dials, joysticks, etc.), for operation of lift device 10. As shown, the HMI 50 may include displays, shown as instrument display 418 and console display 420, input devices, shown as input devices 422, and alert devices or alarms, shown as alert devices 424. In some embodiments, the displays such as instrument display 418 and console display 420 are also input devices, such as touchscreens, and are able to receive operator inputs (e.g., from the operator) in addition to input devices 422. In some embodiments, the HMI 50 is configured to obtain operator inputs from input devices 422 input and provide the operator inputs to the controller 402. In other words, while configured to perform the determinations herein regarding the integrity of the lanyard 210 and PPE system 350, the controller 402 may be further configured to facilitate the general operation of the lift device 10. The operator inputs can indicate a desired operation and/or operational state of lift device 10 or of an apparatus, system, device, sub-system, assembly, etc., of lift device 10. For example, the operator inputs can indicate a requested operation of the lift assembly 14. Controller 402 may respond to the operator inputs by automatically adjusting the information provided to the user via HMI 50 by providing HMI 50 with display data, initiating an automatic alert via HMI 50 via alert devices 424, and/or initiating an automatic action. In some embodiments, the operator may provide operator inputs indicating that the operator has entered the platform assembly 16 and/or is leaving the platform assembly 16, in order to active, deactivate, or otherwise adjust the function of the controller 402 with respect to assessing the integrity of the PPE system 350.

In some embodiments, alert devices 424 can provide auditory alerts to an operator of lift device 10. Alert devices 424 may include speakers, sound output devices, alarms, buzzers, etc. based on the display/alert data provided by controller 402. In some embodiments, alert devices 424 are associated with a corresponding automatic action undertaken by the control system 400. For example, an audible alert or alarm, such as audible natural language-based alerts, indicating that the PPE system 350 is not fully functional may accompany a corresponding action, such as limiting the operation of the lift device 10, initiated by the control system 400. The audible natural language-based alerts can accord to one or more languages.

In some embodiments, the controller 402 may receive image data from the camera 300 as described herein. The controller 402 may include a processing circuit 404, which may include a processor 406 and a memory 408, that facilitates the performance of the systems and methods described herein. For example, the processor 406 may receive the image data and perform object detection (e.g., detecting an object-of-interest) in order to assess the integrity of the PPE system 350 as suggested above. Further, the processor 406 may be configured to compile and utilize a neural network model 407 in order to perform the systems and methods described herein. In order to implement the neural network model 407 on a device, such as the lift device 10, multiple neural network models 407 may be developed in phases in order to optimize the performance of the control system 400.

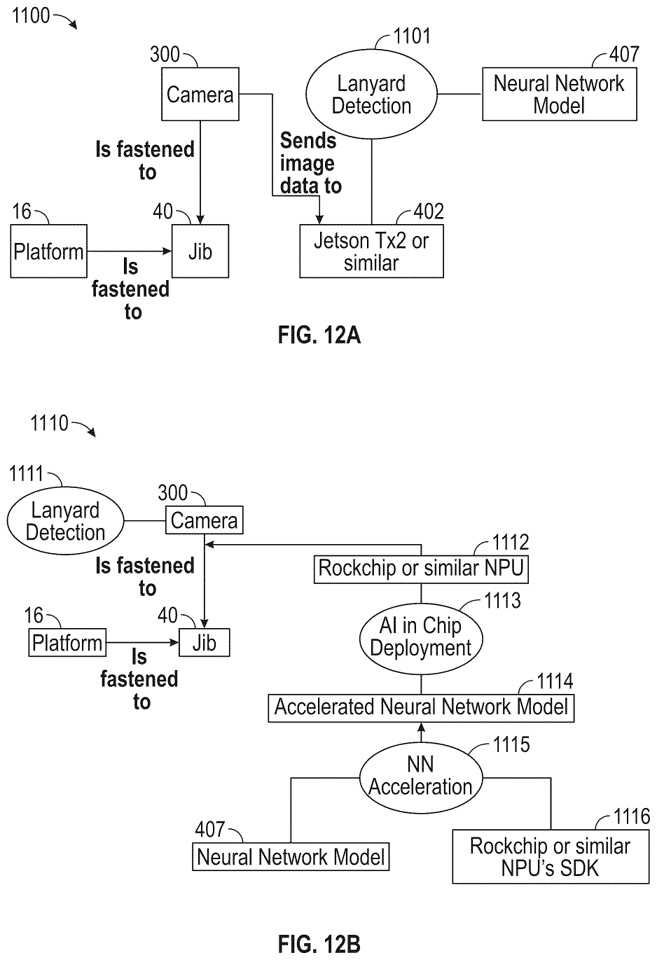

In some embodiments, the control system 400 may operate to constantly assess the integrity of the PPE system 350. Where the control system 400 determines a failure of the integrity (e.g., the lanyard 210 is not coupled to the attachment point 150, the operator is not wearing the harness 230 and/or the jacket 340, the harness 230 is not coupled to the lanyard 210, etc.), the control system 400 may function to provide one or more alerts to the HMI 50 as described above. The control system 400 may further function to adjust the operation of the lift device 10 via the controllable elements 410 (e.g., cease movement of the lift device 10, lower the lift assembly 14 to the ground, etc.). The control system 400 may further function to alert a remote device (such as a supervisor of the operator) over a remote network 412 in communication with the lift device 10. The particular function of the control system 400 is depicted in greater detail below with reference to FIGS. 12A and 12B.

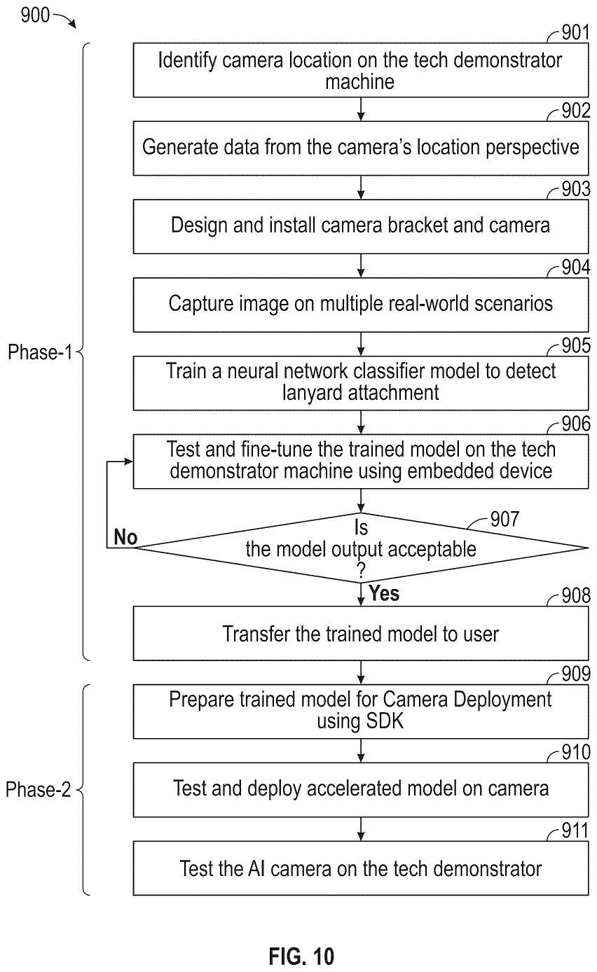

Referring now to FIG. 10, a process 900 for implementing (e.g., providing) the control system 400 (e.g., systems and methods for assessing the integrity of the PPE system 350 as described herein) to a device, such as the lift device 10, is shown, according to some embodiments. At processes 901-903, the camera 300 may be identified in a simulated environment (e.g., relative to an expected platform assembly 16). Simulated data may thus be generated (e.g., synthetic data, operating data, test data, etc.) based on the camera 300's expected mounting location on a demonstration device, which may be the lift device 10. The generated data may be collected for multiple real-world scenarios at process 904, as shown with reference to FIG. 10. The generated data may be used as training data in order to develop a neural network classifier model (e.g., the neural network model 407) for assessing the integrity of the lanyard and PPE system at process 905. At processes 906 and 907, the control system 400 may be applied to a demonstration device, such as the actual lift device 10 in order to iteratively test the performance of the control system 400. For example, the neural network model 407 may be implemented on the controller 402, which may be implemented as the camera 300's neural processing unit (NPU), or separately (e.g., the camera 300 may simply provide the image data to a separately located controller 402, and the controller 402 may provide the NPU. A software development kit (SDK) for the provided NPU (e.g., provided by a chip manufacturer such as Rockchip) SDK for Rockchip may thus be provided along with the trained neural network model 407 from processes above to accelerate or otherwise optimize the function and/or implementation of the control system 400. At process 908, the control system 400, the camera 300, the neural network model 407, and/or the lift device 10 as a whole (depending on the implementation of the processes above) may assembled and provided. At processes 909-911 the control system 400 may be tested further on the provided assembly, which may be based on the software development kid (SDK) used to generate the neural network model 407 at processes 901-907. Upon the completion of process 911, the control system of the lift device 10 may be considered implemented in accordance with performing the systems and methods described herein.

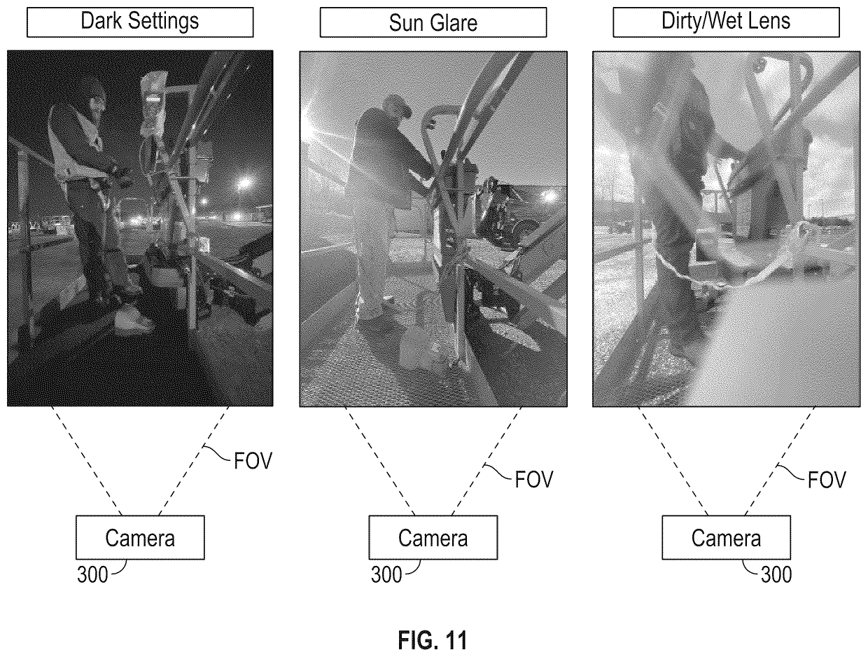

Referring now to FIG. 11, the control system 400 (and the camera 300 therein) may be operable in various real-world environments. For example, in practical use, machines such as the lift device 10 may be used all day across the globe in different lighting and weather conditions (e.g., a dark or night environment, a bright environment that produces glare, an environment that introduces debris, such as water or dirt, onto a lens of the camera 300, etc.). The trained neural network model 407 may be configured to correctly detect if an operator has their lanyard hook attached to the attachment point 150 or not in various lighting conditions. As suggested above with reference to FIG. 9, various real-world conditions may be simulated or tested to train the neural network model 407 in accordance with such scenarios. Further, the platform assembly 16, when raised up in the air by the lift device 10 may, at times, experience wind forces which will cause the platform assembly 16 to oscillate. The camera 300 and/or the neural network model 407 may be configured to compensate the image blur or distortion caused by this wind and movement.

Referring now to FIGS. 12A and 12B, flows 1100 and 1110 are depicted in accordance with exemplary operation(s) of the control system 400, according to some embodiments. For example, and with specific reference to FIG. 12A, the platform assembly 16 may be coupled to the jib (e.g., connecting linkage) 40. The platform assembly 16 and/or the connecting linkage 40 may support the camera 300. The camera 300 may provide image data to the controller 402, which may be an embedded device such as a Jetson TX2 or a similarly operable system. The controller 402 may in turn produce a lanyard detection signal 1101 in accordance with the neural network model 407 as described above. As another example, and with specific reference to FIG. 12B, trained neural network model 407 may be combined (e.g., cross-referenced, integrated, assembled, etc.) (shown as neural network acceleration 1115) with the provided NPU SKD 1116 (as suggested above) in order to provide an accelerated/optimized neural network model 1114 (which may be simply discussed as the neural network model 407 above for clarity). The accelerated neural network model 1114 may in turn enable artificial intelligence for a deployment of the NPU of the camera 300 (or the control system 400/controller 402 as a whole), as shown by AI in Chip Deployment 1113. The AI in Chip Deployment 1113 may in turn be provided as an NPU 1112 for the actual camera 300, controller 402, and/or control system 400 for the lift device 10, which may enable the camera 300 to perform lanyard detection 1111 (separately or in conjunction with the controller 402 and/or the control system 400).

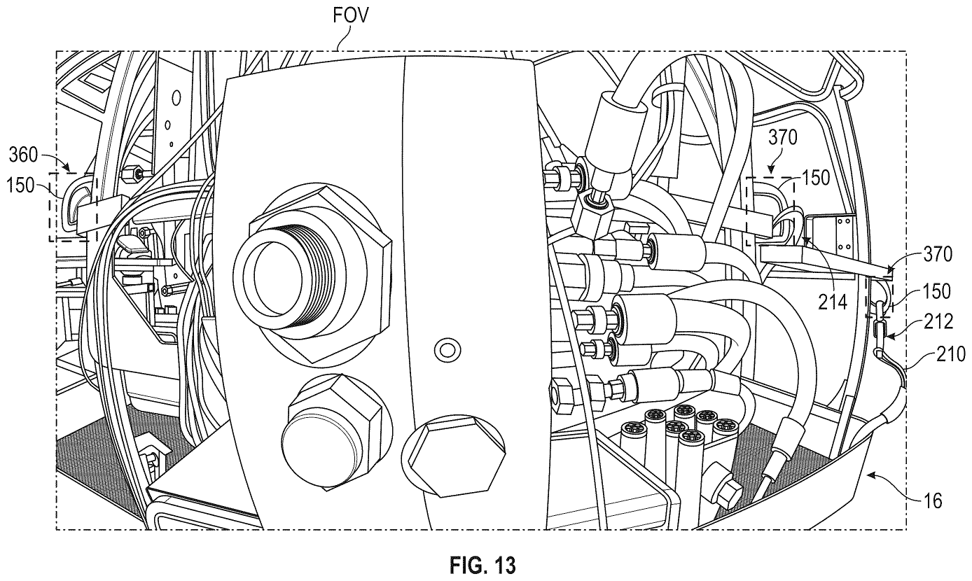

Referring now to FIG. 13, a field of view of the camera 300 is shown, according to exemplary embodiments. The FOV of the camera 300 includes a view of each of the attachment points 150 on the platform assembly 16. In some embodiments, the camera 300 (e.g., in conjunction with the control system 400) is configured to determine a number of operator(s) (e.g., 1, 2, 3, 5, etc.) about (e.g., supported by, standing on) the platform assembly 16. In some embodiments, a weight sensor (e.g., a load cell) may be positioned on or around the platform assembly 16 in order to determine the number of operators present. The camera 300 and/or control system 400 may in turn provide individual determinations regarding multiple attachment points 150, lanyards 210, harnesses 230 and/or jackets 330 with respect to the multiple operators in terms of assessing the integrities of the lanyard and PPE systems.

By way of example, the neural network model 407 described with regards to FIG. 10 is applied by the controller 402 to determine whether each operator is wearing and using the PPE system 350 properly. For example, the neural network model 407 is configured to utilize image data transmitted by the camera 300 to detect each of the attachment points 150 on the platform assembly 16. The neural network model 407 may further be configured to detect whether a lanyard 210 is connected to each of the attachment points 150. By way of example, an attachment point 150 having a lanyard 210 connected is read as a positive attachment 370. A positive attachment 370 indicates that an operator's lanyard 210 is engaged with the attachment point 150. Conversely, an attachment point 150 without an attached lanyard 210 is read as a negative attachment 360. A negative attachment 360 indicates that an operator's lanyard is not engaged with the attachment point 150.

The neural network model 407 may determine a number of operators on the work area 102 of the platform assembly 16. By way of example, the neural network model 407 may determine the number of operators based on weight data transmitted from the load cell and/or based on image data transmitted from the camera 300. In exemplary embodiments, the neural network model 407 compares the number of operators detected on the work area 102 of the platform assembly 16 to the number of positive attachments 370. If the number of positive attachments 370 between the operator lanyards 210 and attachment points 150 matches the number of operators present in the work area 102, then the controller 402 may allow regular operation of the lift device 10. If the number of operators present in the work area 102 is greater than the number of positive attachments 370, then the controller 402 may limit operation of the lift device 10.

For example, if the number of operators present in the work area 102 is greater than the number of positive attachments 370, then the controller 402, then the controller may limit movement of one or more components of the lift device 10 (e.g., the hydraulic cylinder 30, the turntable 26, boom actuators, lift actuators, etc.). In some examples, the controller 402 prevents operation of a prime mover (e.g., an engine, an electric motor, etc.) to inhibit movement of the lift device 10 along a ground surface. Additionally or alternatively, the neural network model 407 may compare the weight received from the load cell to a threshold. Responsive to the weight exceeding the threshold, the controller 402 may operate the HMI 50 to request confirmation regarding the number of operators present in the work area 102. In this example, the controller 402 may limit operation of the lift device 10 until an operator inputs a confirmation regarding the number of operators present in the work area 102.

In some examples, the controller 402 transmits a user interface having graphical representations of the negative attachments 360 and the positive attachments 370 to a user device (e.g., a remote computer, tablet, laptop, mobile phone, the HMI 50, or the like). The graphical user interface may indicate the status of attachment of the second end 214 of the lanyards 210, or other PPE, with the attachment points 150 (e.g., positive attachment, negative attachment) using various symbols, codes, text, or the like. In such examples, the interface may include the FOV of the camera with positive attachments 370 indicated in a first color (i.e., status indicator) and negative attachments 360 indicated in a second color (i.e., status indicator).

The neural network model 407 may determine which operator(s) attempt to operate the lift device 10 without engaging a lanyard 210 with an attachment point 150. As discussed above, the camera 300 collects image data, which may be used to determine whether the operator (if present aboard the platform assembly 16) has the lanyard 210 attached to the attachment point 150. Such image data may further be used to determine whether the operator is wearing the harness 230 and the jacket 340. Each instance of an operator attempting to operate the lift device 10 without engaging a lanyard 210 to an attachment point 150 may be recorded/saved on the memory 408 and transmitted to the remote network 412. Additionally, each instance of an operator attempting to operate the lift device 10 without wearing the harness 230 and/or the jacket 340 may be recorded/saved on the memory 408 and transmitted to the remote network 412. In this way, a remote user (e.g., a fleet manager, an operator supervisor, etc.) may track operator specific instances of failing to engage the lanyard 210 with an attachment point 150 or failing to wear the harness 230 and/or the jacket 340, while attempting to operate the lift device 10.

In some examples, the neural network model 407 may be trained to monitor a lanyard 210 connection to the fall arrest system 200 shown in FIG. 3. Specifically, the neural network model 407 may be trained to detect a connection between the anchor 258 and a lanyard 210, or a connection between the lanyard 210 and the cable assembly 256. In this example, a camera 300 may be positioned such that the fall arrest system 200 is within the FOV of the camera 300. Such a camera may be a first/primary camera positioned on the distal end 13 of the lift device 10 (e.g., as shown in FIG. 6), or may be a secondary camera positioned elsewhere on the platform assembly 16 (e.g., on the railing assembly 110).

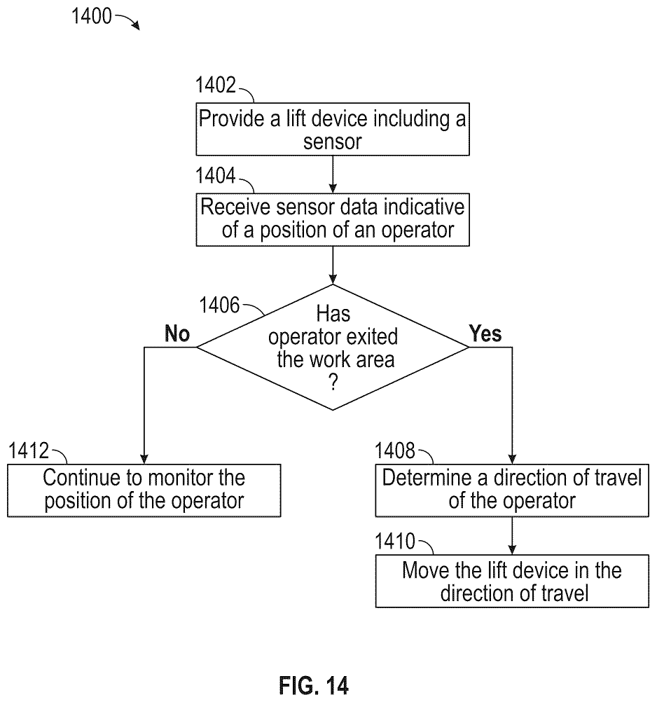

Referring to FIG. 14, a flow diagram of a process 1400 for operating a lift device (e.g., the lift device 10) based on sensor data is shown, according to an exemplary embodiment. A controller (e.g., the controller 402) associated with the lift device performs the process 1400, according to some embodiments.

At step 1402, a lift device having a controller (e.g., the controller 402) thereon is provided to a user/operator. The lift device is outfitted with one or more cameras (e.g., cameras 300) having an FOV of an operator workspace on the lift device (e.g., the work area 102). The cameras alone, or in combination with weight sensors, other optical sensors, or the like may transmit data to the controller indicative of the operator's position relative to the workspace of the lift device. In some examples, the lift device includes one or more speed sensors configured to measure a speed of lift device travel or a speed of travel of one or more operators.

At step 1404, the controller receives the sensor data indicative of the operator's position relative to the workspace of the lift device. In example embodiments, a first camera 300 is mounted to the connecting linkage 40 (i.e., the jib) and captures image data associated with the attachment points 150 of the platform assembly 16 (e.g., as shown in FIG. 13). A second camera may be mounted to the railing assembly 110 and may capture image data associated with the railings 112, the fall arrest system 200, a portion of the interior side of the railings 112 (e.g., the work area 102), and/or a portion of the exterior side of the railings 112. In some examples, a third camera collects image data associated with the surroundings of the platform assembly. The third camera may, for example, be mounted to the railing assembly 110 or on a section of the lift assembly 14. The controller may, additionally or alternatively, receive data from a load cell indicative of the weight on the platform assembly 16.

At step 1406, the controller determines whether an operator's positioned has moved beyond a threshold relative to the workspace of the platform, such as if the operator has exited the workspace of the platform. In some embodiments, the threshold is a perimeter of the workspace. In some embodiments, the threshold is an area of the workspace less than a maximum area of the workspace. In some examples, the controller may detect changes in weight on the platform assembly 16 and determine, based on the change in weight, that an operator exited the platform or moved beyond the threshold. Additionally or alternatively, the controller may, continuously or nearly continuously, perform image recognition on the image data transmitted from the cameras to determine a number of operators present on the platform. If an operator did not exit the platform or move beyond the threshold (e.g., the number of operators detected on the platform did not change relative to a prior detection), at step 1412 the controller continues to monitor the position of each operator relative to the platform. If an operator did exit the platform, the controller continues to step 1408.

At step 1408, the controller determines a direction of travel of the operator who exited the platform. For example, the controller may apply a neural network model (e.g., neural network model 407) that is specifically trained to recognize operator movements, including detecting when the operator is leaving the platform and predicting their direction of travel immediately afterward. The neural network may analyze historical movement patterns and visual cues, such as body orientation or gait, to infer the operator's intended direction. As another example, the controller may determine the direction of travel by analyzing the operator's position within the FOV of the cameras mounted around the platform. If the operator remains within the FOV, the controller can directly map the movement trajectory from one frame to the next, establishing the travel direction based on consecutive positional data. However, if the operator exits the FOV, the controller may infer the direction by analyzing the side of the image where the operator last appeared. For instance, if the operator exits on the left side of the FOV, the controller may determine that the operator is moving in a leftward direction.

In other examples, the controller may actively adjust or move one or more of the cameras to continue tracking the operator after they leave the platform. For example, the cameras may be pan-tilt-zoom (PTZ) cameras that are repositioned by the controller to maintain the operator within the camera's FOV, thereby allowing the controller to continuously track the operator's movement.

Further, the controller may incorporate additional sensor data, such as data transmitted from motion sensors or proximity detectors, to determine the direction of travel (e.g., in scenarios where visual data alone is insufficient or unavailable). The sensors may provide supplementary information about the operator's speed, proximity to obstacles, and/or changes in motion patterns. The controller may determine additional operator behaviors based on the supplementary information. For example, the controller may detect an operator has fallen by comparing the operator's speed to a threshold speed. Additionally or alternatively, the controller may detect that an operator has fallen based on rapid changes in motion pattern.

At step 1410, the controller operates one or more components of the lift device (e.g., hydraulic cylinder 30, turntable 26, lift assembly 14, a prime mover, motors, etc.) based on the direction of travel determined at step 1408. For example, the controller may drive tractive elements (e.g., wheel and tire assemblies 28) to shift the lift device in the direction of travel of the operator outside the platform. The controller may drive the tractive elements until the operator is within the FOV of at least one camera or until the operator is centered within the FOV of at least one of the cameras. As another example, if the controller detects that the operator has moved leftward outside the platform based on step 1408, the controller may simultaneously rotate the turntable 26 and extend the lift assembly 14 in the same direction, allowing the lift device to reorient toward the operator's path.

In situations where the operator is no longer visible within the FOV of any camera, the controller may use predictive algorithms to estimate the operator's position based on their last known travel direction. For instance, the controller may engage the hydraulic cylinder 30 to elevate or lower the platform, allowing the operator to re-enter the FOV of cameras that are positioned at different heights or angles. Additionally, the controller may trigger the movement of motorized cameras to pan or tilt in alignment with the predicted direction of the operator's movement.

In some examples, the controller maintains a predetermined distance between the operator outside of the workspace and the platform. In this way, if the operator were to fall, the platform may act as a basket to catch the operator and mitigate the fall. In some examples, the controller may monitor the speed and angle of the operator's fall using the previously mentioned motion pattern and speed detection techniques to predict a landing area of the operator. If the system detects a rapid, uncontrolled descent indicative of a fall, the controller can engage motors to shift the platform toward the operator's predicted landing area. Simultaneously or nearly simultaneously, the controller may elevate or extend the lift assembly 14 (e.g., by operating one or more actuators, by operating hydraulic cylinder 30, etc.), or rotate the turntable 26 to position the platform in the predicted landing area.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled to one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lift device 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A lift device, comprising:
a chassis;
a platform configured to support an operator, the platform defining a work area having a deck and railing;
a lift assembly coupling the platform to the chassis and configured to raise the platform relative to the chassis;
an actuator configured to at least on of (a) move the platform relative to the chassis or (b) propel the chassis;
a sensor configured to provide sensor data indicative of a position of the operator relative to the work area; and
a controller communicatively coupled to the lift assembly and the actuator, the controller configured to:
receive, from the sensor, data indicative of the operator exiting the work area;
in response to determining that the operator has exited the work area, determine, based on the sensor data, a direction of travel of the operator; and
operate at least one of the lift assembly or the actuator to move the platform according to the direction of travel of the operator.

2. The lift device of claim 1, wherein the sensor is a camera configured to collect image data indicative of a field of view of the camera.

3. The lift device of claim 1, wherein the sensor is a weight sensor configured to collect data indicative of changes in weight on the work area.

4. The lift device of claim 1, further comprising an attachment point configured to engage a lanyard to secure the operator to the platform.

5. The lift device of claim 4, further comprising a camera configured to collect image data indicative of a field of view of the camera, wherein the controller is configured to:
determine, based on the image data, if the lanyard is engaged with the attachment point; and
in response to determining that the lanyard is not engaged with the attachment point, at least one of (a) activate an alarm or (b) limit movement of at least one of the lift assembly or the actuator.

6. The lift device of claim 5, wherein the controller is configured to:
record each instance that the operator attempts to operate the lift device while the lanyard is not engaged with the attachment point; and
transmit the recorded instances to a remote system.

7. The lift device of claim 5, wherein the controller is configured to cause a display to display a user interface having a status indicator, the status indicator indicating whether the lanyard is engaged with the attachment point.

8. The lift device of claim 4, wherein the attachment point is a first attachment point, wherein the platform includes a second attachment point.

9. The lift device of claim 8, further comprising a camera configured to collect image data indicative of a field of view of the camera, wherein the field of view of the camera includes the first attachment point and the second attachment point.

10. The lift device of claim 9, wherein the operator is a first operator of a plurality of operators and the lanyard is a first lanyard, wherein the controller is further configured to:
determine, based on the image data, a number of the plurality of operators that are currently supported by the platform;
determine, based on the image data, if a second lanyard is engaged with the second attachment point; and
in response to a determination that both (a) at least two of the plurality of operators are supported by the platform and (b) the second lanyard is not engaged with the second attachment point, at least one of (a) activate an alarm to alert the operator that the lanyard is not engaged with the attachment point or (b) limit movement of the lift device.

11. The lift device of claim 1, wherein the controller is configured to:
determine, based on the sensor data, a speed of travel of the operator;
determine the speed of travel exceeds a threshold, wherein the speed of travel exceeding the threshold indicates the operator is falling; and
transmit a signal to a remote system indicating that the operator has fallen.

12. The lift device of claim 11 further comprising a plurality of attachment points, wherein the controller is configured to:
determine an attachment point from the plurality of attachment points with which a lanyard of the operator was engaged when the operator fell;
receive a user input indicating whether the attachment point from the plurality of attachment points was replaced; and
in response to receiving a user input indicating that the attachment point from the plurality of attachment points was not replaced, limit movement of at least one of the lift assembly or the actuator.

13. The lift device of claim 11, wherein the controller is configured to:
in response to determining that the operator is falling, determine, based on the sensor data, an expected landing area of the operator; and
operate at least one of the lift assembly or the actuator to move the platform according to the expected landing area of the operator.

14. A lift device, comprising:
a chassis;
a platform configured to support an operator, the platform defining a work area having a deck, a railing, and an attachment point configured to engage a lanyard to secure the operator to the platform;
a lift assembly coupling the platform to the chassis and configured to raise the platform relative to the chassis;
an actuator configured to at least on of (a) move the platform relative to the chassis or (b) propel the chassis;
a camera configured to collect image data indicative of a field of view of the camera; and
a controller communicatively coupled to the lift assembly and the actuator, the controller configured to:
determine, based on the image data, if the lanyard is engaged with the attachment point; and
in response to determining that the lanyard is not engaged with the attachment point, limit movement of at least one of the lift assembly or the actuator.

15. The lift device of claim 14, wherein the controller is configured to:
record each instance that the operator attempts to operate the lift device while the lanyard is not engaged with the attachment point; and
transmit the recorded instances to a remote system.

16. The lift device of claim 14, wherein the attachment point is a first attachment point, wherein the platform includes a second attachment point.

17. The lift device of claim 16, wherein the field of view of the camera includes the first attachment point and the second attachment point.

18. The lift device of claim 17, wherein the operator is a first operator of a plurality of operators and the lanyard is a first lanyard, wherein the controller is further configured to:
determine, based on the image data, a number of the plurality of operators that are currently supported by the platform;
determine, based on the image data, if a second lanyard is engaged with the second attachment point; and
in response to a determination that both (a) at least two of the plurality of operators are supported by the platform and (b) the second lanyard is not engaged with the second attachment point, at least one of (a) activate an alarm to alert the operator that the lanyard is not engaged with the attachment point or (b) limit movement of the lift device.

19. A method for controlling operation of a lift device, comprising:
receiving, from a sensor, data indicative of an operator exiting a work area of a platform of the lift device;
determining, based on the sensor data, a direction of travel of the operator in response to determining that the operator has exited the work area;
operating at least one of a lift assembly or an actuator to move the platform of the lift device according to the direction of travel of the operator;
determining, based on the sensor data, a speed of travel of the operator;
determining the speed of travel exceeds a threshold, wherein the speed of travel exceeding the threshold indicates the operator is falling; and
transmitting a signal to a remote system indicating that the operator has fallen.

20. The method of claim 19, further comprising:
determining, based on the sensor data, an expected landing area of the operator in response to determining that the operator is falling; and
operating at least one of the lift assembly or the actuator to move the platform according to the expected landing area of the operator.
